(19) United States
(12) Patent Application Publication
(10) Pub. No.: US 2018/0336277 A1
(43) Pub. Date: Nov. 22, 2018

(54) Managing Media Collections Using Directed Acyclic Graphs

(71) Applicant: Apple Inc., Cupertino, CA (US)

(72) Inventors: Thomas Alsina, Saratoga, CA (US); Cody D. Jorgensen, San Jose, CA (US); Jason P. Ketterman, San Jose, CA (US); Nicholas J. Paulson, San Francisco, CA (US)

(21) Appl. No.: 15/693,087

(22) Filed: Aug. 31, 2017

Related U.S. Application Data
(60) Provisional application No. 62/506,912, filed on May 16, 2017.

(51) Int. Cl. G06F 17/30; G06F 7/08

(52) U.S. Cl. CPC G06F 17/30772; G06F 7/08; G06F 17/30958; G06F 17/30778

(57) ABSTRACT

In some implementations, a computing device can generate graphs for managing media item collections. For example, the graph can include nodes representing individual media items in a media item collection. Each node can include attributes that define whether the corresponding media item should be played. Each node can include attributes that define one or more next nodes to be played. The next nodes can be ordered consistently across computing devices according to various criteria, (e.g., time when the next node was added to the graph and/or user identifier) so that changes to the graph across devices can be made in a consistent, conflict avoiding manner. The playback sequence for media items represented by the graph can be determined by traversing the nodes in the graph and including or excluding media items from the playback sequence according to the attributes of the corresponding nodes.

### RELATED APPLICATION

This application claims priority to U.S. Provisional Application No. 62/506,912, filed on May 16, 2017, the content of which is incorporated herein by reference in its entirety.

### TECHNICAL FIELD

The disclosure generally relates to playing back and editing media item collections.

### BACKGROUND

Computing devices are used to manage and playback various media items (e.g., music tracks, etc.) and/or media item collections (e.g., playlists, playback queues, etc.). The media items and/or media item collections may be stored locally on a user's computing device, stored remotely in some network server, and/or distributed across multiple computing devices (e.g., user devices). When users make edits to media item collections, the edits may be shared amongst user devices and/or may need to be combined or incorporated into another media item collection. Thus, a data structure for managing media item collections is needed that allows for editing and resolving editing conflicts when they occur.

### SUMMARY

In some implementations, a computing device can generate graphs for managing media item collections. For example, the graph can include nodes representing individual media items in a media item collection. Each node can include attributes that define whether the corresponding media item should be played. Each node can include attributes that define one or more next nodes to be played. The next nodes can be ordered consistently across computing devices according to various criteria, (e.g., time when the next node was added to the graph and/or user identifier) so that changes to the graph across devices can be made in a consistent, conflict avoiding manner. The playback sequence for media items represented by the graph can be determined by traversing the nodes in the graph and including or excluding media items from the playback sequence according to the attributes of the corresponding nodes.

Particular implementations provide at least the following advantages. Edits to media item collections can be managed in a conflict avoiding manner consistently across multiple computing devices.

Details of one or more implementations are set forth in the accompanying drawings and the description below. Other features, aspects, and potential advantages will be apparent from the description and drawings, and from the claims.

### DESCRIPTION OF DRAWINGS

FIG. 1 is a block diagram of an example system for managing media collections using graphs.

FIG. 2 illustrates an example of an ordered graph of nodes representing a collection of media items.

FIG. 3 illustrates example graphs where a media item has been inserted into the corresponding media item collection.

FIG. 4 illustrates an example graph where a media item has been removed from the corresponding media item collection.

FIG. 5 illustrates an example graph where a media item has been moved from the corresponding media item collection.

FIG. 6 illustrates example graphs where a media item has been moved during repeated playback of the corresponding media item collection.

FIG. 7 illustrates example graphs where a media item has been moved during repeated playback of the corresponding media item collection.

FIG. 8 is flow diagram of an example process for inserting media items into a media item collection.

FIG. 9 is flow diagram of an example process for removing media items from a media item collection.

FIG. 10 is flow diagram of an example process for removing media items from a media item collection.

FIG. 11 is flow diagram of an example process for removing media items from a media item collection.

FIG. 12 is a block diagram of an example computing device that can implement the features and processes of FIGS. 1-11.

Like reference symbols in the various drawings indicate like elements.

### DETAILED DESCRIPTION

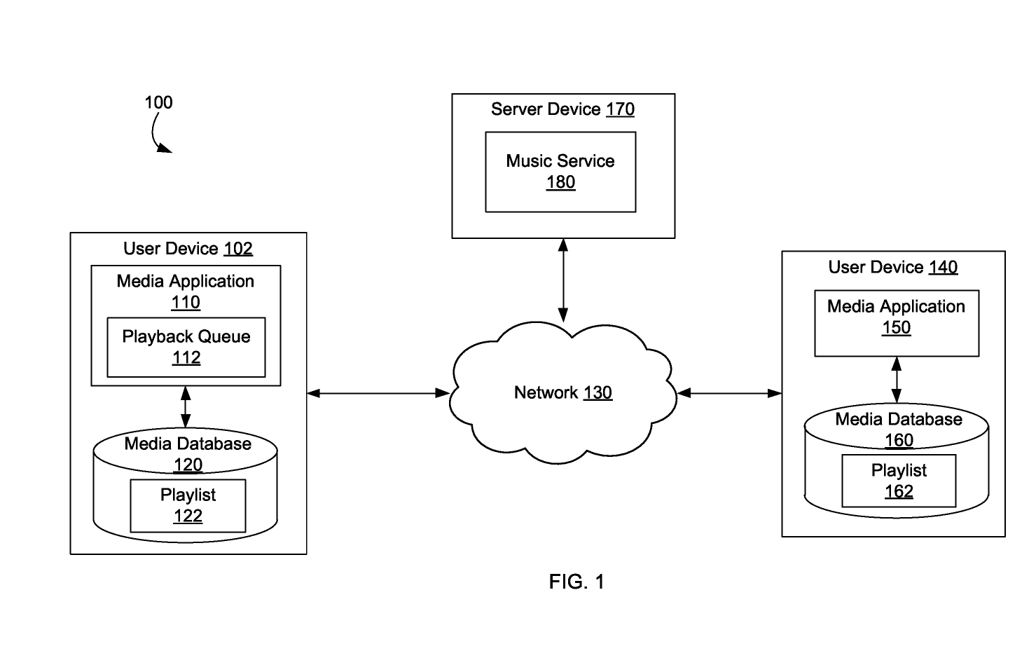

FIG. 1 is a block diagram of an example system 100 for managing media collections using graphs. For example, the graphs can be directed acyclic graphs including nodes for managing media items within the media item collections. For example, system 100 can be configured to share media item collections (e.g., different playlists, different versions of the same playlist, etc.) across multiple devices. Each device can combine or synchronize playlists so that edits made on one device can be incorporated into playlists on other devices. System 100 can be configured to allow different devices to edit media item collections (e.g., playback queues) as the media item collections are being played back by a computing device. Similarly, a user on a particular computing device can make edits to a local media item collection (e.g., playlist, playback queue) on the particular computing device. Thus, system 100 can generate graphs for managing edits to media item collections that have or have not been enqueued for playback by a computing device. For example, a media item collection that has not been enqueued for playback may be referred to herein as a “playlist,” while a media item collection that has been enqueued for playback may be referred to herein as a “playback queue.”

In some implementations, system 100 can include user device 102. For example, user device 102 can be a computing device, such as a laptop computer, a smartphone, a smart watch, a smart speaker (e.g., a speaker with the ability to at least connect to a network and execute applications), a streaming media device (e.g., set top box), or any other type of computing device.

In some implementations, user device 102 may include media application 110. For example, media application 110 can be a software application installed on user device 102. Media application 110 can be part of the operating system of user device 102. Media application 110 can be configured to play media items (e.g., songs, music tracks, movies, talk shows, etc.) and/or media item collections on user device 102. The media items and/or media item collections can be obtained by media application 110 from a network service (e.g., music service 180 on server device 170) through network 140 (e.g., a local area network, wide area network, cellular data network, the Internet, etc.). The media items and/or media item collections can be obtained by media application 110 from another user device (e.g., user device 140) through network 130 or directly (e.g., using Bluetooth, peer-to-peer WiFi, etc.). The media items and/or media item collections can be obtained by media application 110 from local storage (e.g., media data base 120) on user device 102.

In some implementations, media application 110 can generate playback queue 112. For example, media application 110 can generate playback queue 112 based on a media item collection (e.g., playlist). For example, media application 110 can obtain playlist 122 from media database 120 on user device 102 in response to the user of user device 102 selecting to play playlist 122. Alternatively, media application 110 can obtain the playlist from music service 180 on server device 170 or from media database 160 (e.g., playlist 162) on user device 140. When media application 110 obtains the playlist, media application 110 can enqueue the media items in the playlist (e.g. media collection) into playback queue 112 for playback by media application 110 on user device 102. The media items can be enqueued into playback queue 112 according to the order specified by the playlist. For example, the playlist can include an ordered graph of nodes (e.g., a linked list) each representing a media item in the playlist. Media application 110 can enqueue the graph of nodes into playback queue 112 for playback on user device 110. Thus, playback queue 112 can include an ordered graph of nodes. (e.g., a linked list). However, media application 110 performs playback of the media items based on the playback queue 112, rather than the obtained playlist (e.g., playlist 122).

In some implementations, media application 110 can generate playback queue 112 based on individual media items. For example, a user of media application 110 can select an individual media item (e.g., song, music track, talk radio episode, movie, television episode, etc.) from media database 120 for playback by media application 110. In response to receiving the selection, media application 110 can enqueue the individual media item in playback queue 112. For example, if no other media items and/or media item collections (e.g., playlists) have previously been added to playback queue 112, then playback queue 112 may include a graph that includes only the node for the selected individual media item. If the user has previously enqueued a media item or media item collection into playback queue 112, then the selected individual media item can be added to the existing graph of nodes in playback queue 112. For example, the user can specify a location in the playback queue (e.g., a location in a sequence of media items) where the individual media item should be added or where an individual media item should be moved. Media application 110 can add or move the selected individual media item to the user-specified location by adding nodes and/or branches to the graph of nodes, as described below.

In some implementations, media application 110 can receive instructions to edit to playback queue 112 from other devices. For example, while media application 110 on user device 102 (e.g., a smart speaker, media streaming device, etc.) is playing media items in playback queue 112, a user using user device 140 can interact with media application 150 to view and/or modify playback queue 112 on user device 102. For example, media application 150 can receive from media application 110 state information describing the playback state (e.g., currently playing media item, media item to be played next, previously played media items, media items in playback queue 112, etc.) of media application 110. The user of user device 140 can view the playback state of media application 110 through various user interfaces of media application 150. The user can provide input to media application 150 to modify playback queue 112. For example, the user can add media items (e.g., songs) to playback queue 112, remove media items from playback queue 112, and/or rearrange media items in playback queue 112 so that the queued media items will be played in a different order than the order originally or previously specified. When media application 110 receives an instruction to add, remove, or rearrange media items in playback queue 112, media application 110 can modify playback queue 112 by adding new nodes and branches to the corresponding graph of nodes according to implementations described below.

In some implementations, media application 110 can receive instructions to edit to playlist 122. For example, the instructions to edit playlist 122 can be received from other devices, such as server device 170 and/or user device 140. For example, music service 180 may provide playlists curated by various artists or other music experts. The user of user device 102 can download a curated playlist and store the playlist as playlist 122. Later, the curated playlist at server device 170 may be updated or modified by adding a new media item, removing a media item, or changing the order of media items in the playlist. The new version of the playlist may be downloaded to user device 102 and media application 110 can compare the new version of the playlist to playlist 122 to determine the differences between the new version of the playlist and playlist 122. Playlist 122 (e.g., the graph of nodes representing playlist 122) may then be modified by adding new nodes and branches to the corresponding graph of nodes so that playlist 122 corresponds to the new version of the playlist according to implementations described below.

In some implementations, media application 150 on user device 140 can send playlist updates to media application 110 on user device 102. For example, if user device 102 is a smart speaker, the user of user device 140 can send playlist 162 in media database 160 to user device 102 for playback on the smart speaker. User device 102 can store playlist 162 as playlist 122. Later, the user of user device 140 may make some changes to playlist 162 and media application 150 can synchronize the changes with media application 110. For example, media application 150 can send the updated playlist 162 or send a list of changes made to updated playlist 162 to media application 110. Media application 110 can modify playlist 122 to incorporate the changes made to playlist 162 received from media application 150 by adding new nodes and branches to the corresponding graph of nodes so that playlist 122 corresponds to the updated version of playlist 162 according to implementations described below.

### Node Attributes

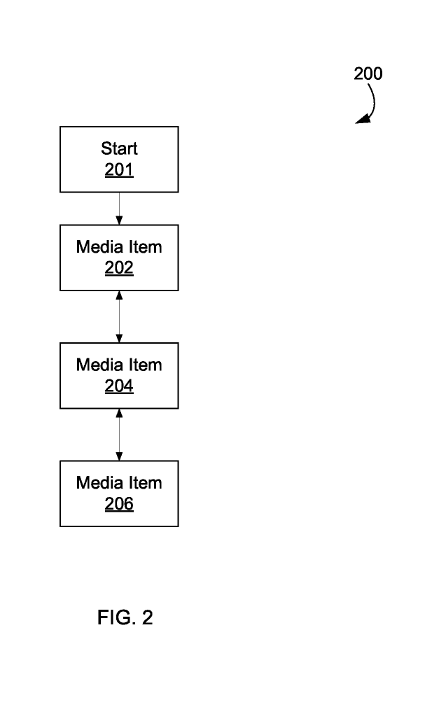

FIG. 2 illustrates an example of an ordered graph of nodes 200 representing a collection of media items. For example, graph 200 (e.g., a directed acyclic graph) can represent a playlist (e.g., playlist 122, playlist 162, etc.). Graph 200 can represent a playback queue (e.g., playback queue 112). Graph 200 can represent an “flattened” or “linear” initial state of the collection of media items. As edits (e.g., additions, deletions, moves, etc.) are made to the collection of media items, graph 200 can be modified to include additional nodes, branches, etc., that represent the edits to the collection of media items, as described below.

In some implementations, graph 200 can include start node 201. For example, start node 201 can be included in the graphs for each collection of media items. Start node 201 may not correspond to a media item but may be used as a starting point or root node for graph 200.

In some implementations, start node 201 can include a collection (e.g., an array, list, etc.) of next node pointers that point to one or more media item nodes. For example, start node 201 can include a next node pointer that points to the first media item node corresponding to the first media item in the corresponding media item collection (e.g., single media item, playlist, playback queue, etc.). If a user later wishes to edit the media item collection to add or move another media item as the first media item in the media item collection, media application 110 can add a pointer to a node representing the other media item to the collection of next node pointers in start node 201.

In some implementations, the next node pointer collection can be ordered according to a position key attribute in each media item node (described below). To determine the order of media items in the collection of media items represented by graph 200, media application 110 can traverse the next node pointer collection of start node 201 according to the order specified by the position key attributes of the media item nodes in the next node pointer collection. In the case of graph 200, the next node pointer collection of start node 201 has only one pointer that points to media item node 202.

In some implementations, graph 200 can include media item nodes 202, 204, and/or 206. In the paragraphs that follow, media item node attributes will be described with reference to node 202, however, each node in graph 200 (or any other media item collection graph described herein) can include the same attributes (described below). Each media item node in graph 200 may have different values for the same attribute. For example, each media item node (e.g., node 202, 204, 206, etc.) can include a media item identifier attribute. However, the value for the media item identifier attribute for node 202 may identify a different media item than the value for the media item identifier attribute for node 204. Thus, each media item node in graph 200 can represent or correspond to a different media item in the corresponding playlist or play queue.

In some implementations, media item node 202 can include a position key attribute. For example and as described above, a media item node's position key can be used by media application 110 to determine a node's position in graph 200. The position key can include a temporal identifier (e.g., playlist version number, timestamp, counter, etc.) indicating when the corresponding media item node was added to the playlist. The position key can include a user identifier (e.g., user identifier, device identifier, etc.) that uniquely identifies the user who added the media item node to graph 200. When determining the order of media item nodes (e.g., pointers to nodes) in next node collections, media application 110 can first sort the nodes by temporal identifier such that nodes added last (e.g., newest nodes) will be traversed first. The user identifier can be used to resolve conflicts between media item nodes that were added at the same time. Thus, when two different users edit a playlist or playback queue at the same time, media application 110 can use the user identifiers of the two users to determine an order for the changes such that the resulting order of media items in the playlist or play queue is consistent between devices. Alternatively, instead of just relying on how user identifiers might be sorted, a particular user can be given priority over other users. For example, changes made by an owner (e.g. originator, curator, etc.) of a playlist, may be given priority over other users with whom the playlist has been shared. Changes by a parent may be prioritized over changes made by a child.

In some implementations, media item node 202 can include a next node collection attribute. For example, the next node collection for media item node 202 can be similar to the next node collection for start node 201. The next node collection for media item node 202 can be, for example, an array or list of pointers to the media item node or nodes to be played next after media item node 202. As illustrated by FIG. 2, the next node collection for media item node 202 can include media item node 204. However, if a user inserts a different media item (e.g., media item node) between media item 202 and media item node 204, media application 110 can add pointer to a new media item node corresponding to the inserted media item into the next node collection for media item node 202. Media application 110 can insert the pointer into the next node collection such that the pointers (e.g., media item nodes) are sorted according to position key. Thus, the most recently added media item nodes in the next node collection will be played first when media application 110 traversed media item collection graph 200.

In some implementations, media item node 202 can include a previous node attribute. For example, the previous node attribute can include a pointer to the previous node in graph 200. The previous node attribute for media item node 202 can point to start node 201, for example, while the previous node attribute for media item node 204 can point to media item node 202. Thus, media application 110 when a user skips forward to a next media item in a playlist or skips backward to a previous media item in a playback queue, media application 110 can use the next nodes pointers and the previous node pointer to traverse forward and backward (e.g., up and down) through graph 200.

In some implementations, media item node 202 can include a cloned nodes collection attribute. For example, when a user moves the media item corresponding to media item node 202 in a playlist or playback queue, the media item node 202 may be cloned (e.g., copied) and the cloned node can be added at the location in the playlist or playback queue specified by the user. When media application 110 clones media item node 202, media application 110 can store a pointer to the cloned node in the cloned nodes collection for media item node 202. Later, media application 110 can use the pointers in the cloned node collection to find all clones of media item node 202. For example, the media item corresponding to media item node 202 may be deleted from, or otherwise unavailable to, user device 102. When media application 110 determines that the media item is no longer available, media application 110 can delete media item node 202 and all clones of media item node 202 pointed to by the cloned node collection.

In some implementations, media item node 202 can include a “userRemoved” attribute. For example, media application 110 can set the userRemoved attribute to “true” to indicate that media item node 202 has been deleted from the corresponding media item collection by the user. When the user removed attribute value is “true”, media application 110 will skip (e.g., ignore) media item node 202 (and the corresponding media item) when determining which media items to playback in the media item collection corresponding to graph 200. When the userRemoved attribute value is set to “false” (e.g., the default value), then media application 110 may include media item node 202 when determining which media items to playback in the media item collection corresponding to graph 200.

In some implementations, media item node 202 can include a “userMoved” attribute. For example, media application 110 can set the userMoved attribute value to “true” to indicate that media item node 202 has been moved in the corresponding media item collection by the user. When the userMoved attribute value is “true”, media application 110 will skip (e.g., ignore) media item node 202 (and the corresponding media item) when determining which media items to playback in the media item collection corresponding to graph 200. However, since moving the media item corresponding to media item node 202 causes media application 110 to clone media item node 202 and insert the cloned node at the destination location specified by the user when providing the move input, the media item corresponding to media item node 202 may still be included in the playlist and/or playback queue. When the userMoved attribute value is set to “false” (e.g., the default value), then media application 110 may include media item node 202 when determining which media items to playback in the media item collection corresponding to graph 200.

In some implementations, media item node 202 can include a “systemRemoved” attribute. For example, media application 110 can set the systemRemoved attribute value to “true” to indicate that the media item corresponding to media item node 202 is no longer accessible by user device 102 and/or media application 110. When media application 110 traverses graph 200 to determine which media items to include in a playlist or playback queue, media application 110 can skip (e.g., omit) media items corresponding to nodes where the systemRemoved attribute value is “true.” When the systemRemoved attribute value is set to “false” (e.g., the default value), then media application 110 may include the media item corresponding to media item node 202 when determining which media items to playback in the media item collection corresponding to graph 200.

In some implementations, media item node 202 can include a “systemMoved” attribute. For example, media application 110 can set the systemMoved attribute to “true” to indicate that media item node 202 has been moved in the corresponding media item collection by music service 180 (or some other external service). For example, music service 180 may receive updated information for a music album or playlist that defines a different order for songs in the music album or playlist. When the music album definition on server device 170 is synchronized with user device 102, media application 110 can move the media items in playlist 122 and/or playback queue 112 to correspond to the updated definition for the music album and set the systemMoved attributes for the moved media item nodes to “true.” When the systemMoved attribute value is “true” for media item node 202, media application 110 will skip (e.g., ignore) media item node 202 (and the corresponding media item) when determining which media items to playback in the media item collection corresponding to graph 200. However, since moving the media item corresponding to media item node 202 causes media application 110 to clone media item node 202 and insert the cloned node at the destination location specified by music service 180, the media item corresponding to media item node 202 may still be included in the corresponding playlist and/or playback queue. When the systemMoved attribute value is set to “false” (e.g., the default value), then media application 110 may include media item node 202 when determining which media items to playback in the media item collection corresponding to graph 200.

In some implementations, media item node 202 can include an “includeIterations” attribute. For example, when media application 110 has been configured to repeat a playlist or other media item collection in a playback queue and the user has moved, added, or deleted a media item in the playback queue, media application 110 can make the move, addition or deletion effective for a specific iteration of the playlist. To include a cloned or added media item node for a particular iteration of playback, media application 110 can specify the effective iteration by adding the iteration number to the includeIterations attribute. For example, the includeIterations attribute can be an array of numbers, where each number in the array identifies an iteration during which the media item corresponding to the media item node (e.g., media item node 202, a clone of media item node 202, or some other node) should be played. For example, a cloned media item node corresponding to a moved media item node can have an includeIterations attribute value of 2 indicating that the cloned node or corresponding media item, should only be played during the second repetition (e.g., iteration) of the playlist. When the includeIterations attribute has at least one value, the corresponding media item node may be excluded from all other playback iterations or repetitions of the playback queue.

In some implementations, media item node 202 can include an “excludeIterations” attribute. For example, when media application 110 has been configured to repeat a playlist or other media item collection in a playback queue and the user has moved, added, or deleted a media item in the playback queue, media application 110 can make the move, addition or deletion effective for a specific iteration of the playlist. To exclude a moved or removed media item node for a particular iteration of playback, media application 110 can specify the effective iteration by adding the iteration number to the excludeIterations attribute. For example, the excludeIterations attribute can be an array of numbers, where each number in the array identifies an iteration during which the media item corresponding to the media item node (e.g., media item node 202, a clone of media item node 202, or some other node) should not be played. For example, a moved or removed media item node can have an excludeIterations attribute value of 2 indicating that the moved or removed node or corresponding media item, should not be played during the second repetition (e.g., iteration) of the playlist. When the excludeIterations attribute has at least one value, the corresponding media item node may be included in all other playback iterations or repetitions of the playback queue.

In some implementations, media item node 202 can include an “excludeShuffle” attribute. For example, media application 110 can be configured to shuffle (e.g., randomly select) media items in a playlist or playback queue for playback on user device 102. To exclude a media item from shuffled playback, the user can provide input indicating that the media item should be excluded from shuffled playback. When media application 110 receives the user input, media application 110 can set the value of the excludeShuffle attribute to “true.” When media application 110 traverses media item collection graph 200 during shuffled playback of the corresponding media item collection, media application 110 can skip (e.g., omit) media item nodes (e.g., media items) that have the excludeShuffle attribute value of “true.”

In some implementations, media item node 202 can include an “explicitContent” attribute. For example, media application 110 can receive metadata for a media item indicating that the media item includes explicit content that may not be suitable for young people (e.g., people below a threshold age). When media application 110 determines that a media item includes explicit content, media application 110 can change the value of the explicitContent attribute of the corresponding media item node from the default “false” value to “true.” When media application 110 is playing a media item collection for a user below an age threshold, media application 110 can skip (e.g., omit) media item nodes (e.g., media items) have a value of “true” for their explicitContent attribute.

In some implementations, media application 110 can use the media item node attributes described above to determine which media items in a media item collection should be played and when they should be played. Media application 110 can use the attributes to determine how to traverse a media item collection graph, such as graph 200, and to determine which media items should be played and which media items should be skipped or omitted from playback. The media item node attributes can also be used to determine how to incorporate edits or changes made to a playlist into the playlist or how to combine two different versions of a playlist. The various media item collection editing operations (e.g., inserting a media item, removing a media item, moving a media item, etc.) are described further below. Media application 110 can perform these operations independently or in combination to provide a full range of editing functionality for playlists and/or playback queues.

### Inserting Nodes

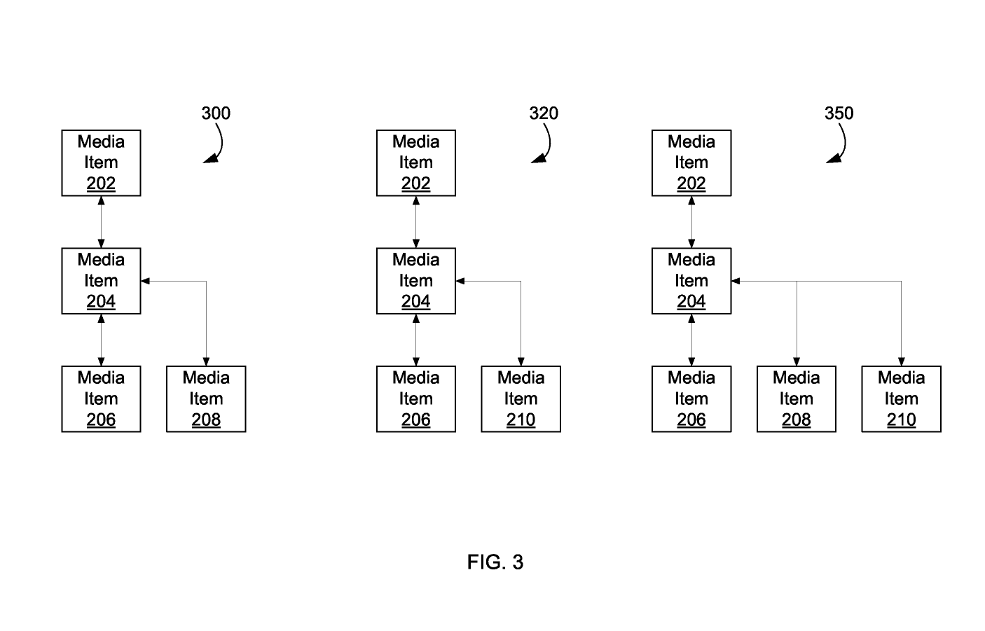

FIG. 3 illustrates example graphs 300, 320, and 350 where a media item has been inserted into the corresponding media item collection. For example, graphs 300, 320 and/or 350 can include similar features and/or attributes as graph 200 described above. Graphs 300, 320, and/or 350 may illustrate how graph 200 may be modified when a media item is added or inserted into the media item collection corresponding to graph 200.

In some implementations, media application 110 can receive a request to insert a media item into a media item collection. For example, media application 110 can receive updates to playlist 122 that indicate a media item should be inserted into the playlist. Media application 110 can receive a request to insert a media item to playback queue 112. When media application 110 receives the request, media application 110 can generate a new media item node 208 corresponding to the inserted media item.

In some implementations, media application 110 can receive a location in graph 300 where media item node 208 should be inserted. For example, the request to insert the media item can identify a location (e.g., after a particular media item, before a particular media item, etc.) in a playlist or playback queue where the new media item should be inserted. For example, media application 110 can receive location information indicating that the media item corresponding to media item node 208 should be inserted after the media item corresponding to media item node 204. Media application 110 can traverse graph 300 until media item node 204 is located and add new media item node 208 to the collection of next nodes in media item 204. As described above, media application 110 can order the nodes (e.g., node pointers) in the next nodes collection according to the position keys of the nodes in the next nodes collection. In this case, the next nodes collection for media item 204 includes media item node 206 and media item node 208. Since media item node 208 is the most recently added node, media application 110 will traverse (e.g., playback) media item node 208 before media item node 206.

In some implementations, two media items may be added to a media item collection at the same time or within a time window of each other. For example, while a user of user device 102 may cause media item node 208 to be added to graph 300, a user of user device 140 may cause media item node 210 to be added to graph 320. Because graph 300 and graph 320 represent the same media item collection, the insertion of media item node 208 and media item node 210 at the same time or within a time window of each other may cause a conflict when trying to determine which of media item node 208 and media item node 210 to traverse first because media item node 208 and media item node 210 may have the same temporal identifier in their respective position keys.

In some implementations, to allow media application 110 to resolve this conflict consistently across devices, media application 110 can use the user identifier in the position key to resolve this conflict and provide a consistent resolution of the conflict across devices. For example, when media application 110 finds that two nodes (e.g., node 208, node 210, etc.) within a next node collection have the same temporal identifier, media application 110 can sort the nodes based on the user identifier in the position key. For example, media item node 210 may have a user identifier that causes media application 110 to order node 210 before media item node 208 in the next nodes collection of media item node 204. By sorting nodes in the next node collection by temporal identifier (e.g., time added) and then user identifier, media application 110 can prioritize the most recent edits over least recent edits while providing consistency in ordering across devices. Thus, when media item collection graph 300 is combined with media item collection graph 320 to create media item collection graph 350, the next nodes collection of media item node 204 can be consistently ordered (e.g., from right to left) such that media item node 210 is traversed first, media item node 208 is traversed second, and media item node 206 is traversed last.

### Removing Nodes

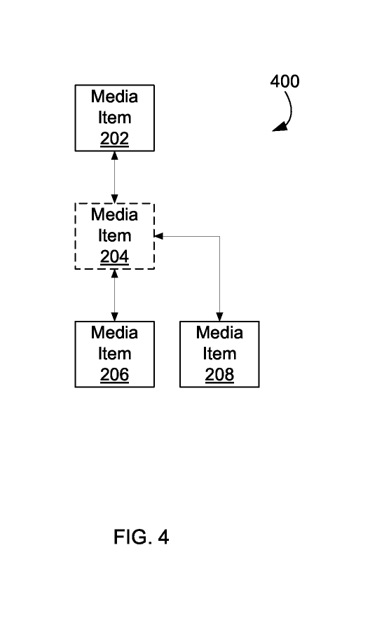

FIG. 4 illustrates an example graph 400 where a media item has been removed from the corresponding media item collection. For example, graph 400 can include similar features and/or attributes as graph 200 described above. Graph 400 may illustrate how graph 200 may be modified when a media item is removed from the media item collection corresponding to graph 200.

In some implementations, media application 110 can receive an instruction to remove a media item from a media item collection. For example, a user of user device 102 can provide input to media application 110 to cause media application 110 to remove a media item from a playlist or playback queue. The user may have grown tired of a particular media item corresponding to media item node 204. The user can provide input to media application 110 to remove media item 204 (e.g., media item node) from the media item collection corresponding to graph 400. In response to receiving the instruction to remove media item node 204, media application 110 can traverse graph 400 until media item node 204 is reached. Media application 110 can then change the value of the “userRemoved” attribute of node 204 to “true” to cause media application 110 to omit (e.g., as indicated by the dashed line around media item node 204) the media item corresponding to media item node 204 when playing back the media item collection corresponding to graph 400.

In some implementations, the attributes of a removed media item node may be analyzed by media application 110 to determine how to traverse graph 400. For example, although the media item corresponding to media item node 204 may be omitted from playback, media application 110 can traverse the next nodes collection of media item node 204 to determine that media item node 208 should be traversed before media item node 206. In contrast to a system remove instruction (described below), a user initiated instruction to remove media item node 204 may not cause the removal of nodes cloned from media item node 204.

In some implementations, media application 110 can receive a system level instruction to remove a media item from a media item collection. A system level instruction can be an instruction that is initiated by a computing device or application/service on a computing device. A system level instruction may not be initiated by a user of a user device (e.g., via user input to media application 110). A system level instruction to remove a media item may be given priority over a user instruction to move a media item. For example, media application 110 may determine that the media item corresponding to media item node 204 is no longer accessible to user device 102. In response to determining that the media item corresponding to media item node 204 is no longer accessible to user device 102, media application 110 can change the value of the “systemRemoved” attribute of media item node 204 to “true.” Media application 110 can also traverse all clones of node 204 pointed to by the cloned nodes collection attribute of media item node 204 and change the value of the “systemRemoved” attribute of each of the clones of media item node 204 to “true.” Thus, media application 110 will not try to playback the media item corresponding to media item node 204, and its clones, when the media item is unavailable to user device 102.

### Moving Nodes

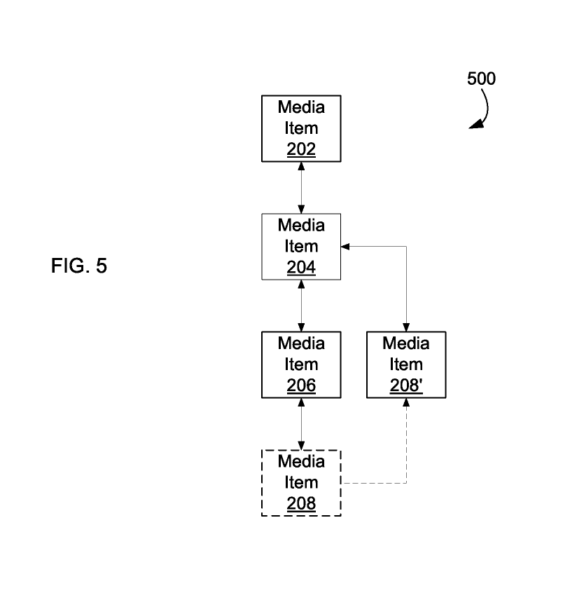

FIG. 5 illustrates an example graph 500 where a media item has been moved from the corresponding media item collection. For example, graph 500 can include similar features and/or attributes as graph 200 described above. Graph 500 illustrates how graph 200 may be modified when a media item is moved from one location to another location in the media item collection corresponding to graph 200.

In some implementations, media application 110 can receive an instruction to move a media item within a media item collection. For example, a user can provide input to media application 110 to move a media item corresponding to media item node 208 from a start location in a playlist or playback queue corresponding to graph 500 to a destination location within the playlist or playback queue. To move media item node 208, media application 110 can generate a new clone 208′ of media item node 208, insert the cloned node 208′ at the destination location specified by the user, and remove node 208 from graph 500, as described above. For example, if a user provides input indicating that media item node 208 should be moved from the end of graph 500 to a position after media item node 204, media application 110 can generate a clone 208′ of media item node 208 and insert the clone node 208′ into the next nodes collection of media item 204. Media application 110 can then insert a pointer to clone node 208′ into the cloned nodes collection of media item 208 and change the value of the “userMoved” attribute of media item 208 to “true.” Thus, when traversing graph 500, media application 110 can traverse clone node 208′ after media item 204 and omit the media item corresponding to media item node 208 (as indicated by dashed line) at the end of graph 500.

In some implementations, media application 110 can receive a system level instruction to move a media item in the media item collection corresponding to graph 500. For example, playlist 122 can correspond to a sequence of media items (e.g., an album, curated playlist, etc.) provided by music service 180. Later, the sequence of media items can be changed at music service 180. Music service 180 can send the new definition for playlist 122 to user device 102 and media application 110 can perform a system level move of media items in playlist 122 according to the new definition received from music service 180. A system level move can be performed similarly to the user move described above. However, a user move may be prioritized over a system level move where a system level move and a user initiated move conflict. For example, if the new definition for playlist 122 indicates that media item node 208 should be moved from the end of graph 500 to a position after media item node 204, media application 110 can generate a clone 208′ of media item node 208 and insert the clone node 208′ into the next nodes collection of media item 204. Media application 110 can then insert a pointer to clone node 208′ into the cloned nodes collection of media item 208 and change the value of the “systemMoved” attribute of media item 208 to “true.” Thus, when traversing graph 500, media application 110 can traverse clone node 208′ after media item 204 and omit the media item corresponding to media item node 208 (as indicated by dashed line) at the end of graph 500.

### Moving Nodes During Repeated Playback

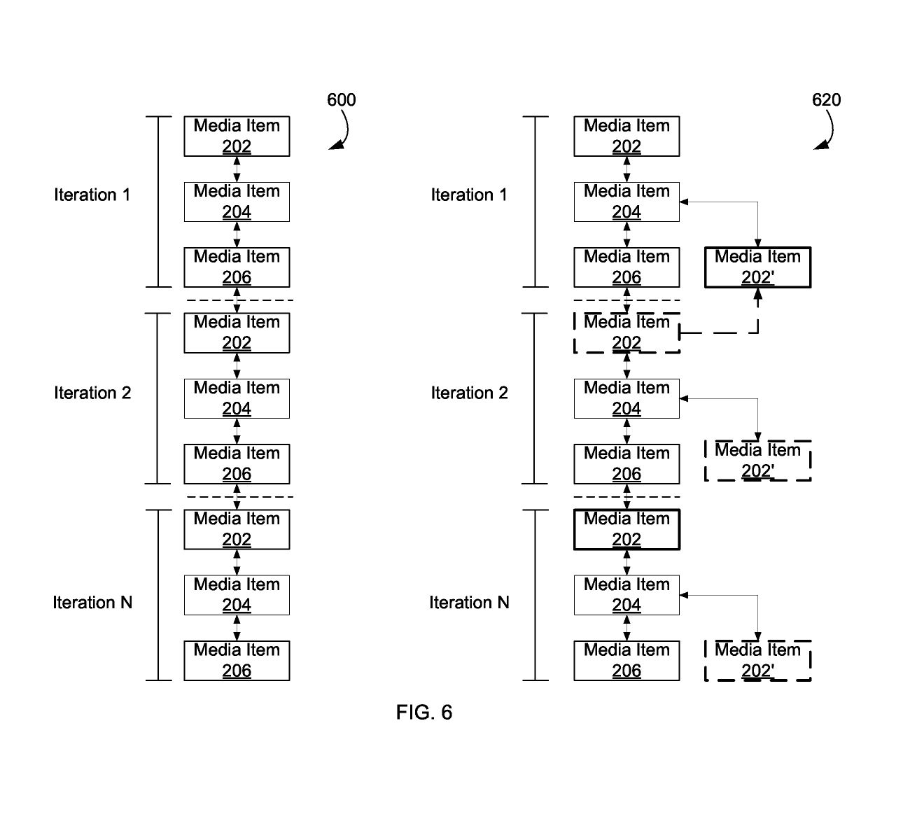

FIG. 6 illustrates example graphs 600 and 620 where a media item has been moved during repeated playback of the corresponding media item collection. For example, graphs 600 and 620 can include similar features and/or attributes as graph 200 described above. Graphs 600 and 620 illustrate how graph 200 may be modified when a media item is moved from one location to another location during repeated playback of the media item collection corresponding to graph 200.

In some implementations, media application 110 can be configured to perform repeated playback of a media item collection. For example, a user may provide input to media application 110 to select playlist 122 for playback. Media application 110 can load playlist 122 into playback queue 112. Media application 110 can receive additional user input indicating that the user wishes media application 110 to repeat the playback of playlist 122. Thus, media application 110 can repeat the playback of playlist 122 in playback queue 112. For example, media application 110 can repeat multiple iterations of the graph of playlist 122 in playback queue 112, as illustrated by graph 600.

In some implementations, media application 110 can edit playback queue 112 while repeating playback of playlist 122. Referring to graph 620, for example, a user can provide input to media application 110 to change the order of playback for media items in playback queue 112. Media application 110 can, for example, enqueue playlist 122 into playback queue 112 and loop through several iterations (e.g., iteration 1, iteration 2, iteration N, etc.) of playlist 122, as illustrated by graph 600 and graph 620. Since graphs 600 and 620 represent looped playback of the same playlist, nodes having the same identifiers in different iterations (e.g., node 204 in iteration 1, node 204 in iteration 2, etc.) represent the same nodes.

In some implementations, media application 110 can present a representation of the media items in playback queue 112 on a display of user device 102. In some implementations, media application 150 can present a representation of the media items in playback queue 112 on a display of user device 140. For example, the representations of the media items in playback queue 112 can include representations of multiple iterations of playlist 122. A user can provide input to media application 110 or media application 150 to change the order of playback of media items in playback queue 112. For example, when input is provided to media application 150 to change playback queue 112, media application 150 can send instructions to media application 110 to cause media application 110 to change the order of media items in playback queue 112.

In some implementations, edits to playback queue 112 during repeated playback may only change the specific playback iteration that was modified by the user. For example, when a user removes media item 204 from iteration 2, media application 110 will present media item 204 in subsequent iterations (e.g., iteration 3, iteration N, etc.). When a user provides input to remove media item 204 from iteration 2, for example, media application 110 can enter the number two (2) in the “excludeIterations” attribute of media item node 204. When media application 110 iterates through the second iteration of graph 620, media application 110 can determine based on the excludeIterations attribute that the media item corresponding to media item node 204 should be excluded from the second iteration of playback. Media application 110 can then omit the media item corresponding to media item node 204 from the second iteration of playback.

Similarly, when a user moves a media item within the playback queue, media application 110 can move the media item for only the specified iteration or iterations of playback. For example, a user can provide input to media application 110 to move a media item between iterations of playback. A user may really love the media item (e.g., song) corresponding to media item node 202. The user can provide input to move media item node 202 from the second iteration (e.g., iteration 2) to a position right after media item node 204 in iteration one. In response to receive the user input, media application 110 can generate a clone (e.g., cloned node 202′) of media item node 202 and insert cloned node 202′ in the next nodes collection of media item node 204. Media application 110 can then insert the iteration identifier for iteration 1 (e.g, the number 1) into the “includeIterations” attribute of cloned node 202′ to cause media application 110 to only play the media item corresponding to cloned node 202′ during iteration 1 of repeated playback. Thus, on subsequent iterations (e.g., iterations 2, 3, . . . , N, etc.) through the enqueued playlist, media application 110 will omit the media item corresponding to cloned media item node 202′, as indicated by the dashed lines around media item node 202′ in iterations 2 and N of graph 620. Media application 110 can insert the iteration identifier for iteration 2 (e.g., the number 2) into the “excludeIterations” attribute of media item node 202 to cause media application 110 to only exclude media item node 202 from iteration 2, as indicated by the dashed line around media item node 202 in iteration 2 of graph 620. Thus, on subsequent iterations (e.g., iterations 3, 4, . . . , N, etc.) through the enqueued playlist, media application 110 will playback the media item corresponding to media item 202.

### Inserting Nodes During Repeated Playback

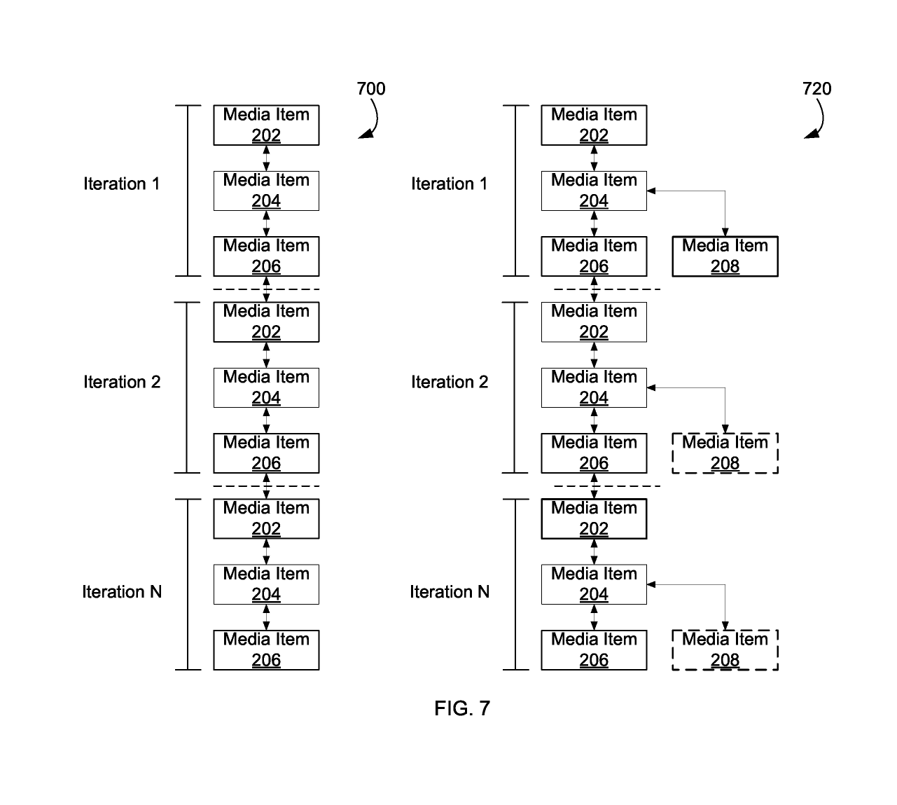

FIG. 7 illustrates example graphs 700 and 720 where a media item has been moved during repeated playback of the corresponding media item collection. For example, graphs 700 and 720 can include similar features and/or attributes as graph 200 described above. Graphs 700 and 720 illustrate how graph 200 may be modified when a media item is inserted into a playback queue during repeated playback of the media item collection corresponding to graph 200.

As described above, media application 110 can be configured to perform repeated playback of a media item collection. For example, a user may provide input to media application 110 to select playlist 122 for playback. Media application 110 can load playlist 122 into playback queue 112. Media application 110 can receive additional user input indicating that the user wishes media application 110 to repeat the playback of playlist 122. Thus, media application 110 can repeat the playback of playlist 122 in playback queue 112. For example, media application 110 can repeat multiple iterations of the graph of playlist 122 in playback queue 112, as illustrated by graph 700.

In some implementations, media application 110 can edit playback queue 112 while repeating playback of playlist 122. Referring to graph 720, for example, a user can provide input to media application 110 to insert a media item corresponding to media item node 208 in playback queue 112. Media application 110 can, for example, enqueue playlist 122 into playback queue 112 and loop through several iterations (e.g., iteration 1, iteration 2, iteration N, etc.) of playlist 122, as illustrated by graph 700 and graph 720. Since graphs 700 and 720 represent looped playback of the same playlist, nodes having the same identifiers in different iterations (e.g., node 204 in iteration 1, node 204 in iteration 2, etc.) represent the same nodes having the same attribute values.

In some implementations, media application 110 can present a representation of the media items in playback queue 112 on a display of user device 102. In some implementations, media application 150 can present a representation of the media items in playback queue 112 on a display of user device 140. For example, the representations of the media items in playback queue 112 can include representations of multiple iterations of playlist 122, as illustrated by graph 720. A user can provide input to media application 110 or media application 150 to insert media items in playback queue 112. For example, when input is provided to media application 150 to insert a media item into playback queue 112, media application 150 can send instructions to media application 110 to cause media application 110 to insert the user-selected media item in playback queue 112 at a user selected location in playback queue 112.

In some implementations, edits to playback queue 112 during repeated playback may only change the specific playback iteration that was modified by the user. For example, when a user provides input to media application 110 (or media application 150) to insert a media item into playback queue 112, media application 110 can generate a new media item node 208 corresponding to the media item to be inserted. Media application 110 can then insert media item node 208 at the location in playback queue 112 selected by the user. For example, if the user input indicated that the new media item should be inserted after media item node 204 in iteration 1, then media application 110 can add new media item node 208 to the next nodes collection of media item node 204. Since the user indicated that media item node 208 should be inserted into iteration 1, media application 110 can add the identifier for iteration 1 (e.g., the number 1) to the “includeIterations” attribute of media item node 208. When media application 110 traverses graph 720, media application 110 can include the media item corresponding to media item node 208 during playback of iteration 1, while excluding media item node 208 from playback during other iterations (e.g., iteration 2, iteration N, etc.). Thus, the repeated playback of playlist 122 will only be modified for the specific iteration indicated by the user.

As described above, when the various graphs above correspond to playback queues, media application 110 can traverse the various graphs above to determine which media items to play and in what order to play them.

Alternatively, when the various graphs above correspond to playlists, media application 110 can traverse the graphs above to determine how to make edits to playlists. For example, a playlist can start as a flat graph (e.g., a sequence of nodes with no branches). A playlist can be edited by performing the remove, insert, and move operations described above on the flat graph to create a branching graph. Media application 110 can traverse the graph and determine based on the attributes of each node in the graph, which media items should be included in the playlist. Media application 110 can then generate a flat graph representing the media items that should be included in the playlist based on the traversal of the branched graph.

It should also be clear from the description above, that modifications to the graphs described above can be initiated locally on user device 102 through direct user interaction with media application 110. In some implementations, modifications to the graphs described above can be initiated remotely by music service 180 on server device 170 or by a user interacting with media application 150 on user device 140. For example, user device 102 may not have a display for presenting a graphical user interface of media application 110. Thus, a user may interact with media application 150 on user device 140 to send playlists, edits, etc., to media application 110 for presentation by user device 102. For example, when user device 102 is a smart speaker, a user may select playlists on user device 140 and send the playlists to media application 110 on user device 102 for playback. When the user wishes to edit playlist 122 or playback queue 112, the user may provide input to media application 150 to edit playlist 122 or playback queue 112. Media application 150 can then send the edits to media application 110 and media application 110 can apply the edits (e.g., remove media item, insert media item, move media item, etc.) to playback queue 112 and/or playlist 122, as described above.

### Example Processes

To enable the reader to obtain a clear understanding of the technological concepts described herein, the following processes describe specific steps performed in a specific order. However, one or more of the steps of a particular process may be rearranged and/or omitted while remaining within the contemplated scope of the technology disclosed herein. Moreover, different processes, and/or steps thereof, may be combined, recombined, rearranged, omitted, and/or executed in parallel to create different process flows that are also within the contemplated scope of the technology disclosed herein. Additionally, while the processes below may omit or briefly summarize some of the details of the technologies disclosed herein for clarity, the details described in the paragraphs above may be combined with the process steps described below to get a more complete and comprehensive understanding of these processes and the technologies disclosed herein.

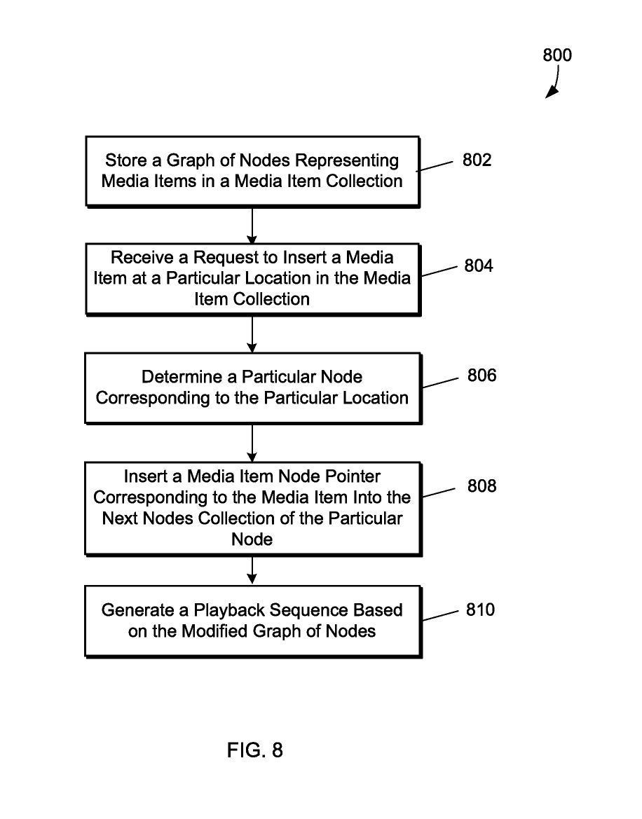

FIG. 8 is flow diagram of an example process 800 for inserting media items into a media item collection. For example, process 800 can be performed by media application 110 on user device 102.

At step 802, user device 102 can store a graph of nodes representing media items in a media item collection. The media item collection can correspond to a playlist (e.g., playlist 122). The media item collection can correspond to a playback queue (e.g., playback queue 112). The graph can be a flat graph representing an unmodified media item collection. The graph can be a branching directional acyclic graph representing modified (e.g., edited) media item collection.

At step 804, user device 102 can receive a request to insert a media item at a particular location in the media item collection. For example, a user of user device 102 can provide input to media application 110 selecting a media item and indicating a location within the media item collection where the selected media item should be inserted. The location can be relative to other media items in the media item collection. For example, the user can indicate that the selected media item should be inserted after a first media item and before a second media item. For example, the user may simply drag and drop the selected media item into a list of media items presented by media application 110 on user device 102. Alternatively, the request to insert the media item can be received from another user device (e.g., user device 140) or from a network service, such as music service 108 on server device 170, as described above.

At step 806, user device 102 can determine a particular node corresponding to the particular location. For example, when media application 110 receives a request to insert a first media item immediately after a second media item, media application 110 can determine the media item node in the graph of nodes corresponding to the second media item.

At step 808, user device 102 can insert a media item node pointer corresponding to the media item into the next nodes collection of the particular node. For example, media application 110 can generate a media item node corresponding to the media item to be inserted into the media item collection. Media application 110 can insert the generated media item node into the graph of nodes by adding a pointer to the generated media item node into the next nodes collection of the particular node corresponding to the particular location. As described above, the pointers in the next nodes collection can be sorted based on the position keys of the nodes pointed to by the pointers.

At step 810, user device 102 can generate a playback sequence based on the modified graph of nodes. For example, to determine the playback sequence for a playlist and/or playback queue, media application 110 can traverse the graph of nodes and determine, based on the attribute data of each node, which media items to include in the playback sequence and which media items to exclude from the playback sequence (e.g., playlist, playback queue, etc.) as described above.

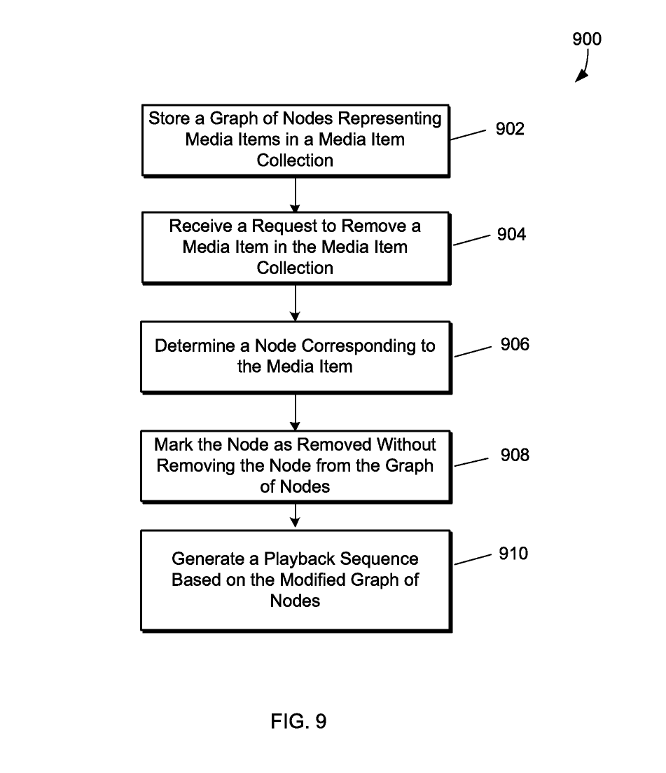

FIG. 9 is flow diagram of an example process 900 for removing media items from a media item collection. For example, process 900 can be performed by media application 110 on user device 102.

At step 902, user device 102 can store a graph of nodes representing media items in a media item collection. The media item collection can correspond to a playlist (e.g., playlist 122). The media item collection can correspond to a playback queue (e.g., playback queue 112). The graph can be a flat graph representing an unmodified media item collection. The graph can be a branching directional acyclic graph representing modified (e.g., edited) media item collection.

At step 904, user device 102 can receive a request to remove a media item in the media item collection. For example, a user of user device 102 can provide input to media application 110 selecting a media item to remove from the media item collection. Alternatively, the request to remove the media item can be received from another user device (e.g., user device 140) or from a network service, such as music service 108 on server device 170, as described above.

At step 906, user device 102 can determine a node corresponding to the media item. For example, the media item can have a particular media item identifier (e.g., URL, number, file path, etc.). Media application 110 can traverse the node graph comparing the particular media item identifier of the media item to media item identifiers in nodes of the node graph until media application 110 finds a node having the particular media item identifier. Thus, media application 110 can determine a node corresponding to the media item by finding a node in the node graph that has the particular media item identifier.

At step 908, user device 102 can mark the node as removed. For example, media application 110 can assign a “true” value to the “userRemoved” attribute of the node when a user initiated the removal of the media item corresponding to the node. Media application 110 can assign a “true” value to the “systemRemoved” attribute of the node when a system (e.g., user device 102) or service (e.g., media service 180) initiated the removal of the media item corresponding to the node.

At step 910, user device 102 can generate a playback sequence based on the modified graph of nodes. For example, to determine the playback sequence for a playlist and/or playback queue, media application 110 can traverse the graph of nodes and determine, based on the attribute data of each node, which media items to include in the playback sequence and which media items to exclude from the playback sequence (e.g., playlist, playback queue, etc.) as described above.

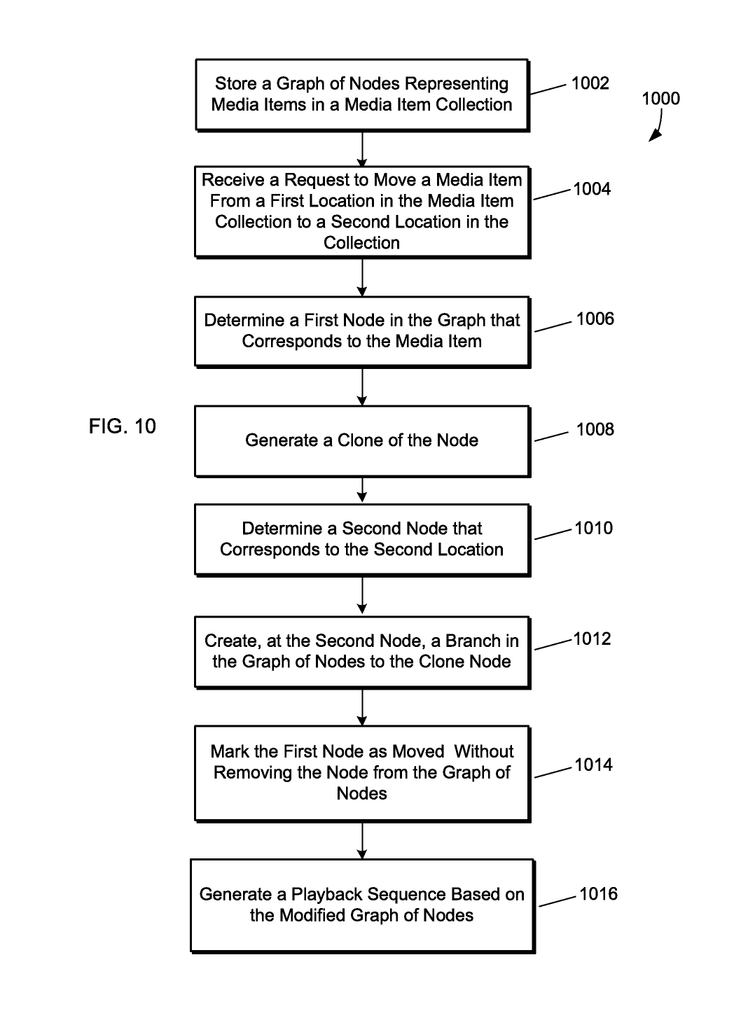

FIG. 10 is flow diagram of an example process 1000 for removing media items from a media item collection. For example, process 1000 can be performed by media application 110 on user device 102.

At step 1002, user device 102 can store a graph of nodes representing media items in a media item collection. The media item collection can correspond to a playlist (e.g., playlist 122). The media item collection can correspond to a playback queue (e.g., playback queue 112). The graph can be a flat graph representing an unmodified media item collection. The graph can be a branching directional acyclic graph representing modified (e.g., edited) media item collection.

At step 1004, user device 102 can receive a request to move a media item from an initial location to a destination location in the media item collection. For example, a user of user device 102 can provide input to media application 110 selecting a media item in the media item collection and indicating a destination location within the media item collection where the selected media item should be moved. The location can be relative to other media items in the media item collection. For example, the user can indicate that the selected media item should be inserted after a first media item and before a second media item. For example, the user may drag the selected media item from a first location and drop the selected media item into a destination location in a list of media items presented by media application 110 on user device 102. Alternatively, the request to insert the media item can be received from another user device (e.g., user device 140) or from a network service, such as music service 108 on server device 170, as described above.

At step 1006, user device 102 can determine a first node in the graph of nodes that corresponds to the media item. For example, the media item can have a particular media item identifier (e.g., URL, number, file path, etc.). Media application 110 can traverse the node graph comparing the particular media item identifier of the media item to media item identifiers in nodes of the node graph until media application 110 finds a node having the particular media item identifier. Thus, media application 110 can determine a node corresponding to the media item by finding a node in the node graph that has the particular media item identifier.

At step 1008, user device 102 can generate a clone of the first node. For example, media application 110 can generate a clone of the first node by copying all of the attributes of the first node into a second node (e.g., the clone node).

At step 1010, user device 102 can determine a second node that corresponds to a second location. For example, media application 110 can determine a second node that corresponds to the destination location in the media item collection. The destination location can, for example, correspond to a node in the graph. For example, when the user indicates that the media item should be moved to a location in the media item collection immediately after a second media item, media application 110 can traverse the node graph until media application 110 finds a node (e.g., the second node) corresponding to the second media item.

At step 1012, user device 102 can create, at the second node, a branch in the graph of nodes to the clone node. For example, media application 110 can create the branch by adding a pointer to the clone node into the next node collection of the second node. Media application 110 can also add a pointer to the clone node to the cloned nodes collection of the first node.

At step 1014, user device 102 can mark the first node as moved. For example, media application 110 can set the “userMoved” attribute or the “systemMoved” attribute of the first node to true to indicate that the first node has been moved to a different location in the graph, as described above.

At step 1016, user device 102 can generate a playback sequence based on the modified graph of nodes. For example, to determine the playback sequence for a playlist and/or playback queue, media application 110 can traverse the graph of nodes and determine, based on the attribute data of each node, which media items to include in the playback sequence and which media items to exclude from the playback sequence (e.g., playlist, playback queue, etc.) as described above. When a node has a userMoved attribute or a systemMoved attribute that has a “true” value, media application 110 can omit the media item corresponding to the node from the playlist or playback queue.

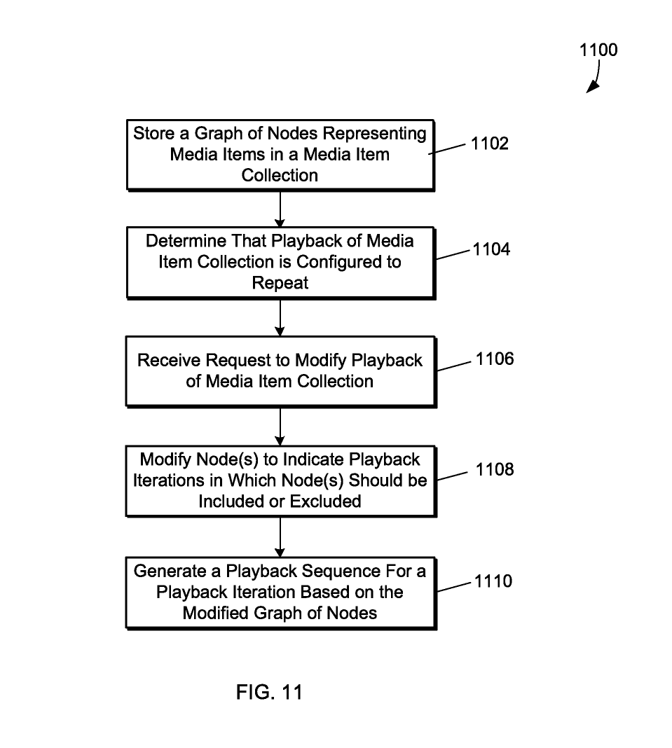

FIG. 11 is flow diagram of an example process 1100 for removing media items from a media item collection. For example, process 1100 can be performed by media application 110 on user device 102.

At step 1102, user device 102 can store a graph of nodes representing media items in a media item collection. The media item collection can correspond to a playlist (e.g., playlist 122). The media item collection can correspond to a playback queue (e.g., playback queue 112). The graph can be a flat graph representing an unmodified media item collection. The graph can be a branching directional acyclic graph representing modified (e.g., edited) media item collection.

At step 1104, user device 102 can determine that playback of the media item collection is configured to repeat. For example, media application 110 can receive user input indicating that the user wishes media application 110 to repeat playback of a playlist or playback queue. Media application 110 can store a value indicating that playback of the media item collection should be repeated. Media application 110 can determine that playback of the media item collection is configured to repeat based on the stored value.

At step 1106, user device 102 can receive a request to modify playback of the media item collection. For example, while media application 110 is configured to perform repeated playback of a media item collection, media application 110 can receive a request to remove, move, or insert a media item in the media item collection. The request can specify a specific iteration of repeated playback to modify.

At step 1108, user device 102 can modify node(s) to indicate playback iterations in which the node(s) should be included or excluded. For example, when media application 110 receives a request to remove, move or insert a media item in the media item collection, media application 110 can identify the node to be moved or removed and/or generate a new node (or cloned node) to be inserted into the media item collection. When removing a media item from a playback iteration, media application 110 can update the “excludeIterations” attribute of the corresponding node to indicate the playback iteration from which the corresponding media item should be excluded. When inserting a media item into a playback iteration, media application 110 can update the “includeIterations” of the corresponding new node (or cloned node) to indicate the playback iteration in which the corresponding media item should be included. When a media item is moved within a playback queue during repeated playback, media application 110 can clone the node corresponding to the media item to generate a clone node corresponding to the media item. The clone node can then be inserted into a destination location in the playback queue designated by the user. Media application 110 can then update the “includeIterations” attribute of the clone node to indicate in which playback iterations the clone node should be included and update the “excludeIterations” attribute of the moved node to indicate in which playback iterations the moved node should be excluded, as described above.

At step 1110, user device 102 can generate a playback sequence for a playback iteration based on the modified graph of nodes. For example, to determine the playback sequence for a repeated playlist and/or playback queue, media application 110 can traverse the graph of nodes and determine, based on the attribute data of each node, which media items to include in the playback sequence and which media items to exclude from the playback sequence (e.g., playlist, playback queue, etc.) as described above. When a node has a includeIterations attribute or an excludeIterations attribute that has a iteration identifier, media application 110 include or exclude the media item corresponding to the node from the identified iterations, as described above.

The paragraphs above describe various implementations where a media item collection (e.g., playlist, playback queue, etc.) can be shared and edited by various different computing devices. In some implementations, the playback device (e.g., the computing device actually playing the media items in the playback queue) is the authority for what is included in a media item collection; other devices may have versions of the media item collection in various states but the playback device has the “official” version of the media item collection. In other words, the playback device manages the truth data (e.g., graph) for the media item collection. In some implementations, management of the media item collection is decentralized. For example, edits to a media item collection can be propagated to other devices and, due to the conflict resolution features described above, each device can incorporate the changes and end up with the same graph for the media item collection.

### Privacy

The present disclosure recognizes that the use of such personal information data, in the present technology, can be used to the benefit of users. For example, the personal information data can be used to deliver targeted content that is of greater interest to the user. Accordingly, use of such personal information data enables calculated control of the delivered content. Further, other uses for personal information data that benefit the user are also contemplated by the present disclosure.

The present disclosure further contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. For example, personal information from users should be collected for legitimate and reasonable uses of the entity and not shared or sold outside of those legitimate uses. Further, such collection should occur only after receiving the informed consent of the users. Additionally, such entities would take any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices.

Despite the foregoing, the present disclosure also contemplates embodiments in which users selectively block the use of, or access to, personal information data. That is, the present disclosure contemplates that hardware and/or software elements can be provided to prevent or block access to such personal information data. For example, in the case of advertisement delivery services, the present technology can be configured to allow users to select to “opt in” or “opt out” of participation in the collection of personal information data during registration for services. In another example, users can select not to provide location information for targeted content delivery services. In yet another example, users can select to not provide precise location information, but permit the transfer of location zone information.

### Example System Architecture

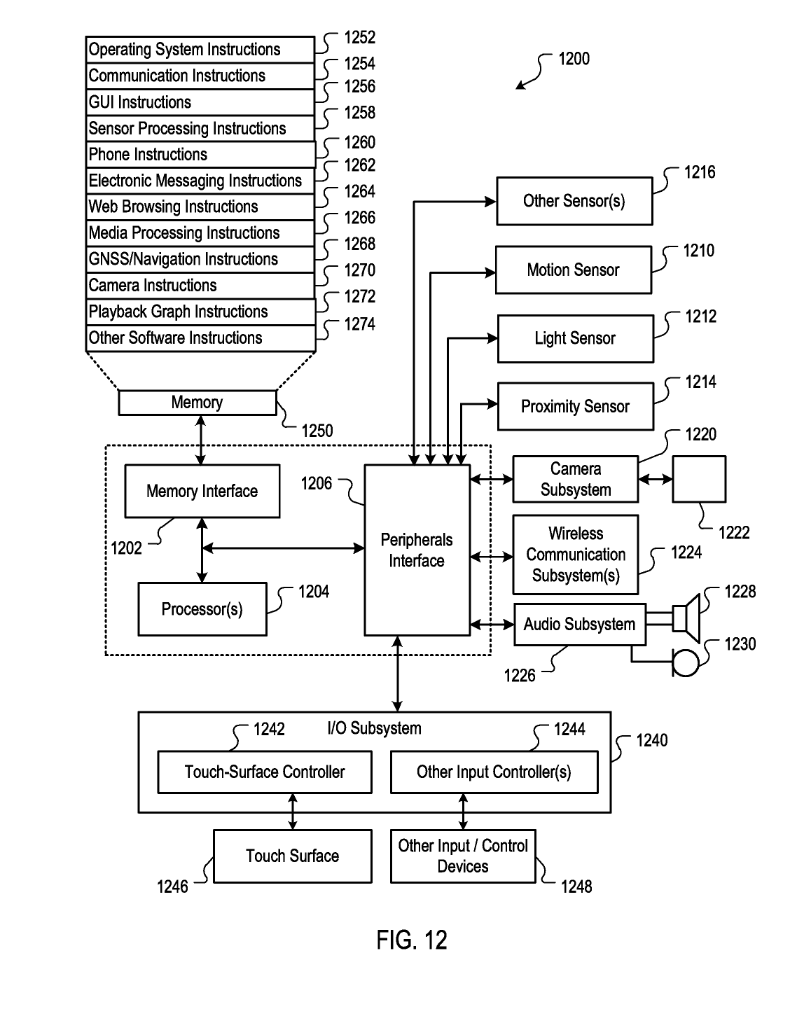

FIG. 12 is a block diagram of an example computing device 1200 that can implement the features and processes of FIGS. 1-11. The computing device 1200 can include a memory interface 1202, one or more data processors, image processors and/or central processing units 1204, and a peripherals interface 1206. The memory interface 1202, the one or more processors 1204 and/or the peripherals interface 1206 can be separate components or can be integrated in one or more integrated circuits. The various components in the computing device 1200 can be coupled by one or more communication buses or signal lines.

Sensors, devices, and subsystems can be coupled to the peripherals interface 1206 to facilitate multiple functionalities. For example, a motion sensor 1210, a light sensor 1212, and a proximity sensor 1214 can be coupled to the peripherals interface 1206 to facilitate orientation, lighting, and proximity functions. Other sensors 1216 can also be connected to the peripherals interface 1206, such as a global navigation satellite system (GNSS) (e.g., GPS receiver), a temperature sensor, a biometric sensor, magnetometer or other sensing device, to facilitate related functionalities.

A camera subsystem 1220 and an optical sensor 1222, e.g., a charged coupled device (CCD) or a complementary metal-oxide semiconductor (CMOS) optical sensor, can be utilized to facilitate camera functions, such as recording photographs and video clips. The camera subsystem 1220 and the optical sensor 1222 can be used to collect images of a user to be used during authentication of a user, e.g., by performing facial recognition analysis.

Communication functions can be facilitated through one or more wireless communication subsystems 1224, which can include radio frequency receivers and transmitters and/or optical (e.g., infrared) receivers and transmitters. The specific design and implementation of the communication subsystem 1224 can depend on the communication network(s) over which the computing device 1200 is intended to operate. For example, the computing device 1200 can include communication subsystems 1224 designed to operate over a GSM network, a GPRS network, an EDGE network, a Wi-Fi or WiMax network, and a Bluetooth™ network. In particular, the wireless communication subsystems 1224 can include hosting protocols such that the device 100 can be configured as a base station for other wireless devices.

An audio subsystem 1226 can be coupled to a speaker 1228 and a microphone 1230 to facilitate voice-enabled functions, such as speaker recognition, voice replication, digital recording, and telephony functions. The audio subsystem 1226 can be configured to facilitate processing voice commands, voiceprinting and voice authentication, for example.

The I/O subsystem 1240 can include a touch-surface controller 1242 and/or other input controller(s) 1244. The touch-surface controller 1242 can be coupled to a touch surface 1246. The touch surface 1246 and touch-surface controller 1242 can, for example, detect contact and movement or break thereof using any of a plurality of touch sensitivity technologies, including but not limited to capacitive, resistive, infrared, and surface acoustic wave technologies, as well as other proximity sensor arrays or other elements for determining one or more points of contact with the touch surface 1246.

The other input controller(s) 1244 can be coupled to other input/control devices 1248, such as one or more buttons, rocker switches, thumb-wheel, infrared port, USB port, and/or a pointer device such as a stylus. The one or more buttons (not shown) can include an up/down button for volume control of the speaker 1228 and/or the microphone 1230.

In one implementation, a pressing of the button for a first duration can disengage a lock of the touch surface 1246; and a pressing of the button for a second duration that is longer than the first duration can turn power to the computing device 1200 on or off. Pressing the button for a third duration can activate a voice control, or voice command, module that enables the user to speak commands into the microphone 1230 to cause the device to execute the spoken command. The user can customize a functionality of one or more of the buttons. The touch surface 1246 can, for example, also be used to implement virtual or soft buttons and/or a keyboard.

In some implementations, the computing device 1200 can present recorded audio and/or video files, such as MP3, AAC, and MPEG files. In some implementations, the computing device 1200 can include the functionality of an MP3 player, such as an iPod™. The computing device 1200 can, therefore, include a 36-pin connector that is compatible with the iPod. Other input/output and control devices can also be used.

The memory interface 1202 can be coupled to memory 1250. The memory 1250 can include high-speed random access memory and/or non-volatile memory, such as one or more magnetic disk storage devices, one or more optical storage devices, and/or flash memory (e.g., NAND, NOR). The memory 1250 can store an operating system 1252, such as Darwin, RTXC, LINUX, UNIX, OS X, WINDOWS, or an embedded operating system such as VxWorks.

The operating system 1252 can include instructions for handling basic system services and for performing hardware dependent tasks. In some implementations, the operating system 1252 can be a kernel (e.g., UNIX kernel). In some implementations, the operating system 1252 can include instructions for performing voice authentication. For example, operating system 1252 can implement the media item collection management features as described with reference to FIGS. 1-11.

The memory 1250 can also store communication instructions 1254 to facilitate communicating with one or more additional devices, one or more computers and/or one or more servers. The memory 1250 can include graphical user interface instructions 1256 to facilitate graphic user interface processing; sensor processing instructions 1258 to facilitate sensor-related processing and functions; phone instructions 1260 to facilitate phone-related processes and functions; electronic messaging instructions 1262 to facilitate electronic-messaging related processes and functions; web browsing instructions 1264 to facilitate web browsing-related processes and functions; media processing instructions 1266 to facilitate media processing-related processes and functions; GNSS/Navigation instructions 1268 to facilitate GNSS and navigation-related processes and instructions; and/or camera instructions 1270 to facilitate camera-related processes and functions.

The memory 1250 can store other software instructions 1272 to facilitate other processes and functions, such as the media item collection management processes and functions as described with reference to FIGS. 1-11.

The memory 1250 can also store other software instructions 1274, such as web video instructions to facilitate web video-related processes and functions; and/or web shopping instructions to facilitate web shopping-related processes and functions. In some implementations, the media processing instructions 1266 are divided into audio processing instructions and video processing instructions to facilitate audio processing-related processes and functions and video processing-related processes and functions, respectively.

Each of the above identified instructions and applications can correspond to a set of instructions for performing one or more functions described above. These instructions need not be implemented as separate software programs, procedures, or modules. The memory 1250 can include additional instructions or fewer instructions. Furthermore, various functions of the computing device 1200 can be implemented in hardware and/or in software, including in one or more signal processing and/or application specific integrated circuits.

What is claimed is:

1. A method comprising:
generating, by a computing device, a graph of nodes representing a collection of media items, where each media item in the collection of media items has a corresponding node in the graph of nodes;
receiving, by the computing device, instructions to modify the collection of media items, wherein the instructions identify at least one media item in the collection of media items;
modifying, by the computing device, the collection of media items by changing at least one attribute of a particular node corresponding to the identified media item;
determining, by the computing device, a playback sequence for the collection of media items based on the at least one attribute in particular node.

2. The method of claim 1, wherein the instructions to modify the collection of media items include instructions to insert a first media item after a second media item in the collection of media items, and further comprising:
generating a first node corresponding to the first media item;
determining a second node corresponding to the second media item; and
inserting a pointer to the first node in a next nodes collection of the second node.

3. The method of claim 2, further comprising:
sorting the pointers in the next nodes collection of the second node based on a position key in the first node.

4. The method of claim 1, wherein the instructions to modify the collection of media items include instructions to remove a media item from the collection of media items, and further comprising:
determining a third node in the media item collection corresponding to the media item; and
changing a value of a moved attribute of the third node to indicate that a third media item corresponding to the third node has been removed from the media item collection.

5. The method of claim 4, further comprising:
determining that the value of the moved attribute of the third node indicates that the third media item corresponding to the third node has been removed from the media item collection; and
omitting the third media item during playback of the media item collection.

6. The method of claim 1, wherein the instructions to modify the collection of media items include instruction to move a media item from a first location in the media item collection to a second location in the media item collection, and further comprising:
determining a fourth node in the media item collection corresponding to the first location;
determining a fifth node in the media item collection corresponding to the second location;
generating a clone of the fourth node;
inserting a first pointer to the clone node into a next node collection of the fifth node;
inserting a second pointer to the clone node into a cloned nodes collection of the fourth node.

7. The method of claim 6, further comprising:
determining that the computing device is configured for repeated playback of the media item collection;
determining a first playback iteration into which the clone node was inserted; and
changing an attribute of the clone node to indicate the first playback iteration.

8. A non-transitory computer readable medium including one or more sequences of instructions that, when executed by one or more processors, cause the processors to perform operations comprising:
generating, by a computing device, a graph of nodes representing a collection of media items, where each media item in the collection of media items has a corresponding node in the graph of nodes;
receiving, by the computing device, instructions to modify the collection of media items, wherein the instructions identify at least one media item in the collection of media items;
modifying, by the computing device, the collection of media items by changing at least one attribute of a particular node corresponding to the identified media item;
determining, by the computing device, a playback sequence for the collection of media items based on the at least one attribute in particular node.

9. The non-transitory computer readable medium of claim 8, wherein the instructions to modify the collection of media items include instructions to insert a first media item after a second media item in the collection of media items, and wherein the instructions cause operations comprising:
generating a first node corresponding to the first media item;
determining a second node corresponding to the second media item; and
inserting a pointer to the first node in a next nodes collection of the second node.

10. The non-transitory computer readable medium of claim 9, wherein the instructions cause operations comprising:
sorting the pointers in the next nodes collection of the second node based on a position key in the first node.

11. The non-transitory computer readable medium of claim 8, wherein the instructions to modify the collection of media items include instructions to remove a media item from the collection of media items, and wherein the instructions cause operations comprising:
determining a third node in the media item collection corresponding to the media item; and
changing a value of a moved attribute of the third node to indicate that a third media item corresponding to the third node has been removed from the media item collection.

12. The non-transitory computer readable medium of claim 11, wherein the instructions cause operations comprising:
determining that the value of the moved attribute of the third node indicates that the third media item corresponding to the third node has been removed from the media item collection; and
omitting the third media item during playback of the media item collection.

13. The non-transitory computer readable medium of claim 8, wherein the instructions to modify the collection of media items include instruction to move a media item from a first location in the media item collection to a second location in the media item collection, and wherein the instructions cause operations comprising:
determining a fourth node in the media item collection corresponding to the first location;
determining a fifth node in the media item collection corresponding to the second location;
generating a clone of the fourth node;
inserting a first pointer to the clone node into a next node collection of the fifth node;
inserting a second pointer to the clone node into a cloned nodes collection of the fourth node.

14. The non-transitory computer readable medium of claim 13, wherein the instructions cause operations comprising:
determining that the computing device is configured for repeated playback of the media item collection;
determining a first playback iteration into which the clone node was inserted; and
changing an attribute of the clone node to indicate the first playback iteration.

15. A system comprising:
one or more processors; and
a non-transitory computer readable medium including one or more sequences of instructions that, when executed by the one or more processors, cause the processors to perform operations comprising:
generating, by a computing device, a graph of nodes representing a collection of media items, where each media item in the collection of media items has a corresponding node in the graph of nodes;
receiving, by the computing device, instructions to modify the collection of media items, wherein the instructions identify at least one media item in the collection of media items;
modifying, by the computing device, the collection of media items by changing at least one attribute of a particular node corresponding to the identified media item;
determining, by the computing device, a playback sequence for the collection of media items based on the at least one attribute in particular node.

16. The system of claim 15, wherein the instructions to modify the collection of media items include instructions to insert a first media item after a second media item in the collection of media items, and wherein the instructions cause operations comprising:
generating a first node corresponding to the first media item;
determining a second node corresponding to the second media item; and
inserting a pointer to the first node in a next nodes collection of the second node.

17. The system of claim 16, wherein the instructions cause operations comprising:
sorting the pointers in the next nodes collection of the second node based on a position key in the first node.

18. The system of claim 15, wherein the instructions to modify the collection of media items include instructions to remove a media item from the collection of media items, and wherein the instructions cause operations comprising:
determining a third node in the media item collection corresponding to the media item; and
changing a value of a moved attribute of the third node to indicate that a third media item corresponding to the third node has been removed from the media item collection.

19. The system of claim 18, wherein the instructions cause operations comprising:
determining that the value of the moved attribute of the third node indicates that the third media item corresponding to the third node has been removed from the media item collection; and
omitting the third media item during playback of the media item collection.

20. The system of claim 8, wherein the instructions to modify the collection of media items include instruction to move a media item from a first location in the media item collection to a second location in the media item collection, and wherein the instructions cause operations comprising:
determining a fourth node in the media item collection corresponding to the first location;
determining a fifth node in the media item collection corresponding to the second location;
generating a clone of the fourth node;
inserting a first pointer to the clone node into a next node collection of the fifth node;
inserting a second pointer to the clone node into a cloned nodes collection of the fourth node.

21. The system of claim 20, wherein the instructions cause operations comprising:
determining that the computing device is configured for repeated playback of the media item collection;
determining a first playback iteration into which the clone node was inserted; and
changing an attribute of the clone node to indicate the first playback iteration.
